(19) United States
(12) Patent Application Publication
(10) Pub. No.: US 2008/0068733 A1
(43) Pub. Date: Mar. 20, 2008

(54) LENS MODULE AND CAMERA MODULE USING THE SAME

(75) Inventor: TIEN-PAO CHEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/695,427

(22) Filed: Apr. 2, 2007

(30) Foreign Application Priority Data
Sep. 15, 2006 (CN) 200610062610.X

(51) Int. Cl. G02B 7/02

(52) U.S. Cl. 359/811

(57) ABSTRACT

A camera module (100) includes a lens module and an image sensor (40), wherein the lens module includes a barrel (10), a plurality of lenses (20) and at least one spacer provided between each pair of neighboring lenses, wherein at least one through hole (14) is defined on a sidewall (12) of the barrel, the spacer is provided with a windpipe communicating with the at least one through hole, and the lenses and the spacer are received in the barrel; the image sensor is located on an imaging plane of the plurality of lenses.

### CROSS-REFERENCE TO RELATED APPLICATION

This application is related to a co-pending U.S. patent application (Attorney Docket No. [US11701]), entitled “LENS MODULE AND CAMERA MODULE USING THE SAME”, by Ching-Lung Jao et al. Such application has the same assignee as the present application and is concurrently filed herewith. The disclosure of the above-identified application is incorporated herein by reference.

### BACKGROUND OF THE INVENTION

1. Field of the Invention

The present invention generally relates to camera modules and especially, to a lens module and a ventilated camera module using the same.

2. Description of Related Art

Nowadays, digital camera modules are in widespread use. Portable electronic devices such as mobile phones and personal digital assistants (PDAs) are becoming increasingly multifunctional, and digital camera modules are now widely available as a special feature for portable electronic devices, consequently the integration of digital camera modules and portable electronic devices has become an important part of mobile multimedia technology.

A typical camera module includes a barrel and a plurality of lenses, the lenses are usually glued and received in the barrel, so that an airtight space is formed between neighboring lenses in the barrel. In high humidity conditions moisture can permeate into the barrel due to the absorption of water by the glue. This moisture may become trapped in the lens structure and may condense on a lens surface causing images formed by the lens structure to be blurred. As a result, the quality of the image formed by the camera module may be affected.

Accordingly, what is needed is a ventilated lens module and camera module using the same that can prevent moisture condensing on lens surfaces.

### SUMMARY

In one aspect thereof, a camera module includes a lens module and an image sensor, wherein the lens module comprises a barrel, a plurality of lenses and at least one spacer spacing each lens from its neighboring lenses. At least one through hole is defined on a sidewall of the barrel, the spacer is provided with a windpipe communicating with the at least one through hole, and the lenses and the spacer are received in the barrel. The image sensor is located on an imaging plane of the plurality of lenses.

Other advantages and novel features will become more apparent from the following detailed description when taken in conjunction with the accompanying drawings.

### BRIEF DESCRIPTION OF THE DRAWINGS

Many aspects of the camera module and the lens module thereof can be better understood with reference to the following drawings. The components in the drawings are not necessarily drawn to scale, the emphasis instead being placed upon clearly illustrating the principles of the present camera module and the lens module thereof. Moreover, in the drawings, like reference numerals designate corresponding parts throughout the several views.

FIG. 1 is an assembled isometric view of a camera module, in accordance with a first embodiment;

FIG. 2 is an exploded isometric view of the camera module in FIG. 1;

FIG. 3 is a cross-sectional view of the camera module taken along line III-III of FIG. 1;

FIG. 4 is an assembled isometric view of the camera module, in accordance with a second embodiment;

FIG. 5 is an exploded isometric view of the camera module in FIG. 4; and

FIG. 6 is a cross-sectional view of the camera module taken along line VI-VI of FIG. 4.

### DETAILED DESCRIPTION OF THE INVENTION

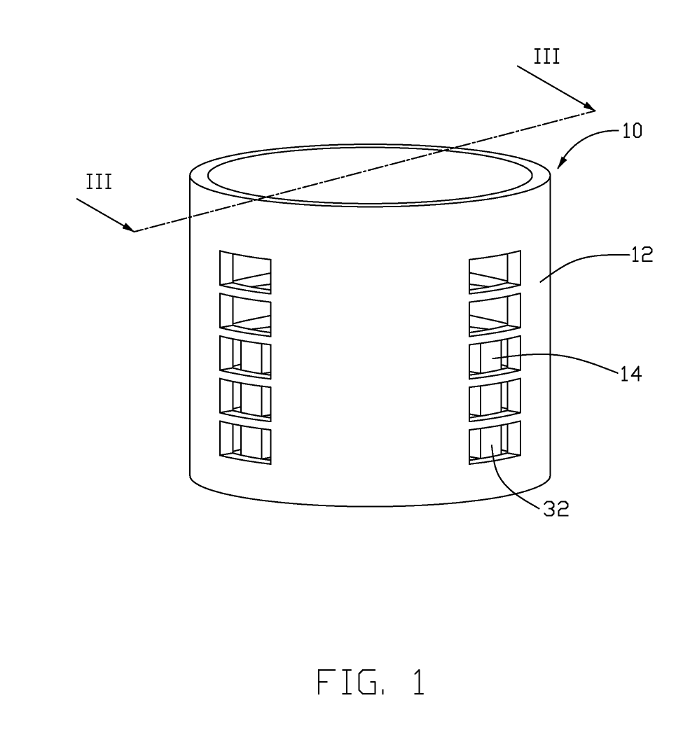

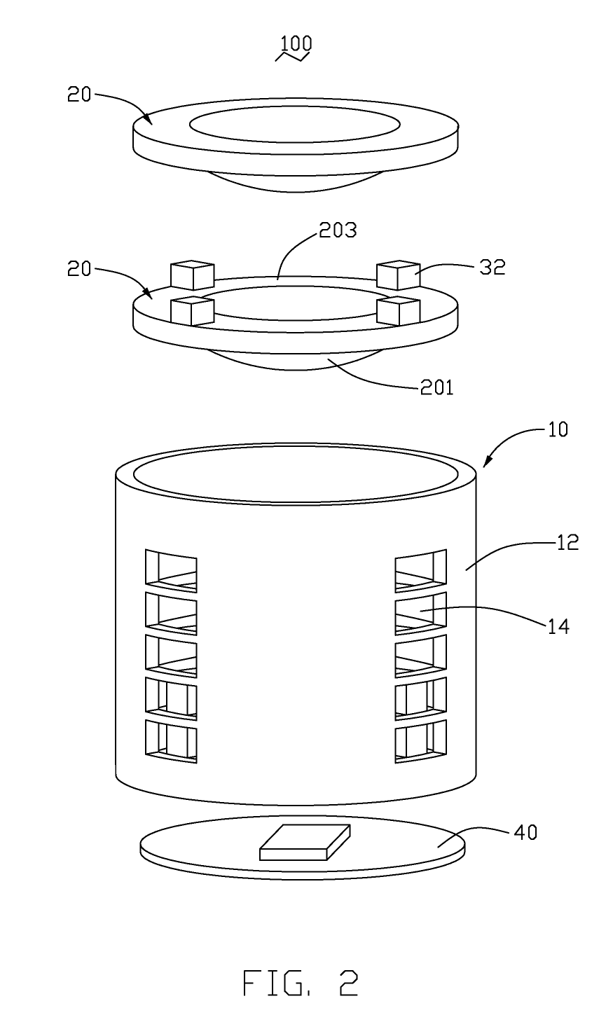

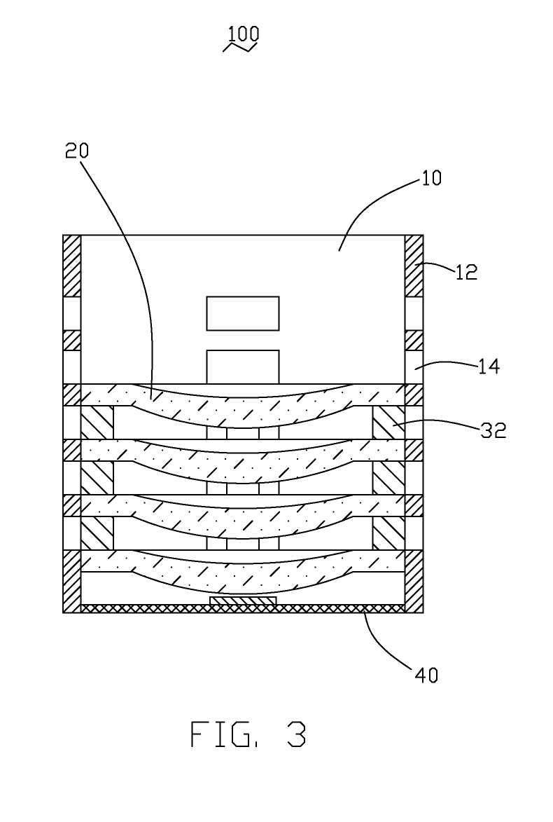

Referring to FIGS. 1-3, a first embodiment of a camera module 100 includes a lens module (not labeled) and an image sensor 40. The lens module includes a barrel 10, a plurality of lenses 20 and at least one spacer provided between each of the lenses 20 and their neighboring lenses 20. The lenses 20 and the spacer are received in the barrel 10. The image sensor 40 is located on an imaging plane of the lens module.

The barrel 10 is a hollow cylinder including a sidewall 12. Twenty through holes 14 are defined on the sidewall 12 and arranged in four rows along an axis of the barrel 10.

The lenses 20 are spherical or aspherical lenses used to focus the light onto the image sensor 40. Each of the lenses 20 includes a base 203 and an optical portion 201 in a central area thereof.

Each of the at least one spacers includes four blocks 32 formed on the base 203 of one of the lenses 20 and four windpipes (not labeled) defined between the four blocks 32. The blocks 32 are used for limiting the distance between the neighboring lenses 20 and improving the optical performance. The blocks 32 are equal in height to holes 14, and a width of the blocks 32 is less than that of the through hole 14. Each of the at least one spacer and the corresponding one of the lenses 20 can be separately formed and then assembled together, and also can be integrally formed.

When the lenses 20 and the blocks 32 are received in the barrel 10 and mated to the sidewall 12 of the barrel 10, each of the blocks 32 faces a corresponding one of the though-holes 14. Due to the width of the blocks 32 being less than that of the at least one through hole 14, the though hole 14 communicates with the windpipes. Of course, each of the windpipes can also face a corresponding through hole 14, and the width of the blocks 32 is not limited being less than the width of the through hole 14. The moisture existing between the neighboring lenses 20 can escape through the windpipes and through holes 14.

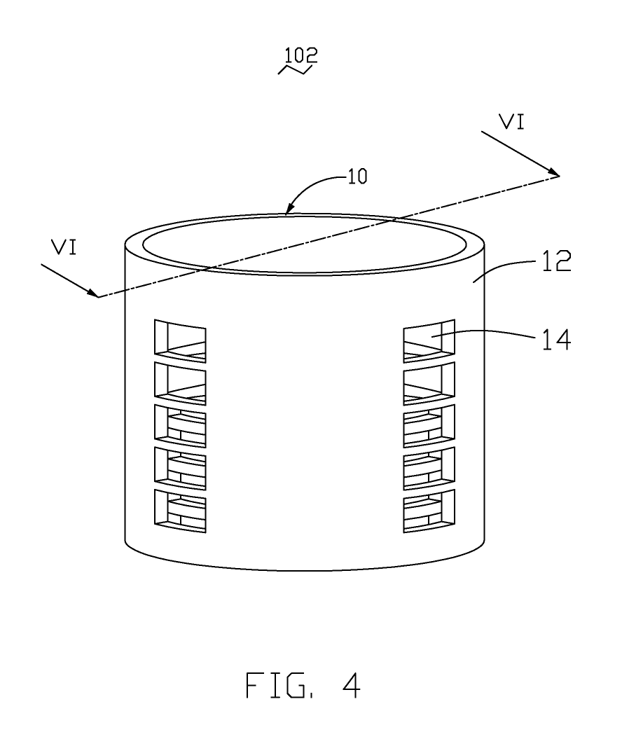

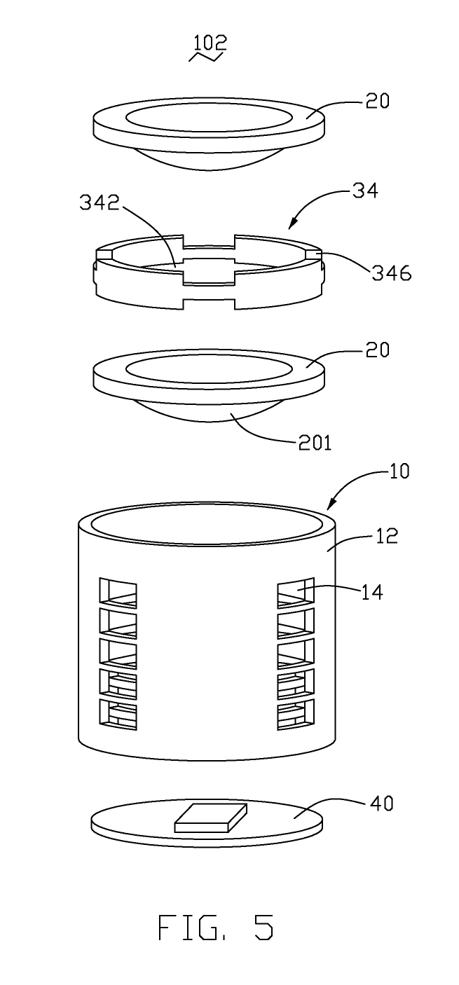

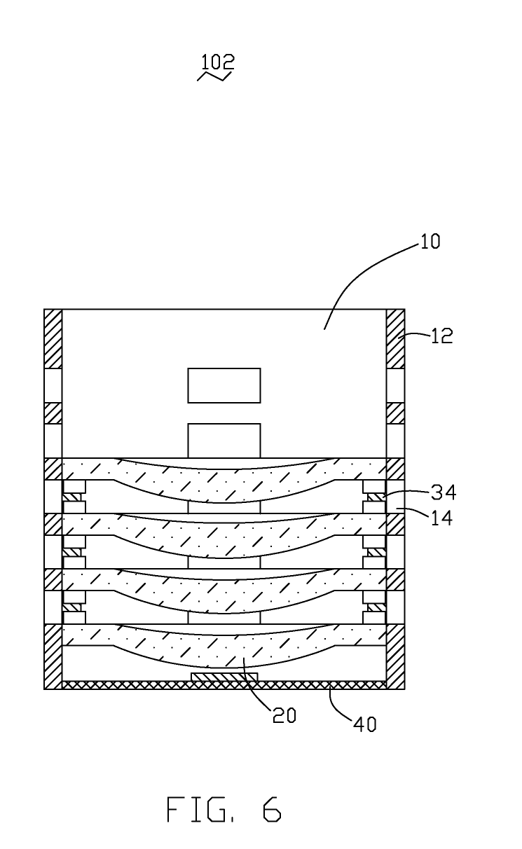

Further referring to FIG. 4-6, a camera module 102 in a second embodiment includes the same barrel 10, lenses 20 and image sensor 40 as the camera module 100 in the first embodiment. The spacer in the second embodiment consists of a spacing ring 34 instead of the blocks 32 in the first embodiment.

The spacing ring 34 has an essentially equal height to the through hole 14 on the barrel 10 and has an external diameter essentially equal to the lenses 20. A light-through hole 342 is defined in a central area of the spacing ring 34. The size of the light-through hole 342 is equal or larger than that of the optical portion 201, so that the spacing ring 34 does not affect the optical performance of the lenses 20. Preferably the light-through hole 342 should have the same shape as the optical portion 201.

A group of indentations 346 are correspondingly defined on a top end and a bottom end of the spacing ring 34 to form a plurality of windpipes. The indentations 346 in the same end of the spacing ring 34 are symmetrical, and each of the indentations 346 faces towards its corresponding through hole 14.

The spacing ring 34 is positioned between neighboring lenses 20. The spacing ring 34 and the lenses 20 are received in the barrel 10 and mated to the sidewall 12 of the barrel 10. The windpipes defined by the indentations 346 communicate with the respective through hole 14. The moisture existing between the neighboring lenses 20 can thus escape through the windpipes and through holes 14.

Alternatively, the indentations 346 on the spacing ring 34 can instead be one or more blowholes (not labeled) on the sidewall of the spacing ring 34, each of the blowholes being connected to a corresponding through hole 14. The through hole 14 in the same row along the axis of the barrel 10 can be replaced with an elongated hole with an end near each of the two ends of the barrel 10. It should be understood that the at least one through hole 14 can be also be replaced with an elongated hole for exhaling the moisture between the lenses 20.

It should be understood that the quantity of the at least one spacer should correspond to that of the lenses 20. If the quantity of the lenses 20 is only two, then there should be one spacer, if there are four lenses 20 then there should be three spacers and so on.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A camera module comprising:
a lens module including a barrel, a plurality of lenses and at least one spacer disposed between each pair of neighboring lenses, wherein the lenses and the spacer are received in the barrel, at least one through hole is defined in a sidewall of the barrel, the at least one spacer is provided with a channel communicating an inner space between the corresponding pair of neighboring lenses with outside of the barrel via the at least one through hole; and
an image sensor located on an imaging plane of the plurality of lenses.

2. The camera module as claimed in claim 1, wherein the at least one through hole is arranged in a row along an axis of the barrel.

3. The camera module as claimed in claim 2, wherein each of the lenses is a spherical or aspherical optical lens including a base and an optical portion in a central area of the base.

4. The camera module as claimed in claim 3, wherein the at least one spacer includes a plurality of blocks formed on the base and a plurality of windpipes defined between the blocks.

5. The camera module as claimed in claim 4, wherein the blocks and the base are integrally formed, or respectively be formed separately and then assembled together.

6. The camera module as claimed in claim 3, wherein the at least one spacer is a spacing ring with a light-through hole being defined in a central area thereof.

7. The camera module as claimed in claim 6, wherein the light-through hole has the same shape as the optical portion.

8. The camera module as claimed in claim 6, wherein a plurality of indentations are defined on a top end and a buttom end of the spacing ring, and the windpipe is defined by the indentations which communicate a space between the optical portions of the corresponding pair of lenses to outside of the barrel via the at least one through hole.

9. The camera module as claimed in claim 6, wherein one or more blowholes are defined in the spacing ring, and the windpipe is formed by the blowholes which communicate a space between the optical portions of the corresponding pair of lenses to outside of the barrel via the at least one through hole.

10. The camera module as claimed in claim 2, the at least one through hole in the same row along the axis of the barrel is an elongated hole with each end near a respective end of the barrel.

11. A lens module comprising:
a barrel with at least one through hole defined on a sidewall thereof;
a plurality of lenses; and
at least one spacer disposed between each pair of neighboring lenses and provided with a windpipe communicating with the at least one through hole, the lenses and the spacer being received in the barrel.

12. The lens module as claimed in claim 11, wherein the at least one through hole is arranged in a row along an axis of the barrel.

13. The lens module as claimed in claim 12, wherein each of the lenses is a spherical or aspherical optical lens including a base and an optical portion in a central area of the base.

14. The lens module as claimed in claim 13, wherein the at least one spacer is integrally formed with the base of one of the corresponding pair of lenses or fixed to the base of one of the corresponding pair of lenses after being formed.

15. The lens module as claimed in claim 13, wherein the at least one spacer includes a plurality of blocks sandwiched between the basees of the corresponding pair of lenses and a plurality of windpipes defined between the blocks.

16. The lens module as claimed in claim 13, wherein the at least one spacer comprises a spacing ring with a plurality of indentations correspondingly defined on a top end and a buttom end thereof, and the windpipe is defined by the indentations which communicate a space between the optical portions of the corresponding pair of lenses to outside of the barrel via the at least one through hole.

17. The lens module as claimed in claim 13, wherein the spacer comprises a spacing ring with one or more blowholes, and the windpipe is formed by the blowholes which communicate a space between the optical portions of the corresponding pair of lenses to outside of the barrel via the at least one through hole.

18. A camera module comprising:
a lens module comprising a barrel having a chamber and a cylindrical sidewall surrounding the chamber, a plurality of spaced lenses fittingly disposed in the chamber, and a spacer disposed between each pair of neighboring lenses to form an inner space between the pair of neighboring lenses surrounded by the spacer, wherein at least one through hole is defined in the sidewall of the barrel and the spacer is provided with a passage communicating the inner space with outside of the barrel via the at least one through hole; and
an image sensor disposed within the chamber and located at an imaging plane of the plurality of lenses.

19. The camera module as claimed in claim 18, wherein each of the lenses comprises a base and an optical portion installed at a central area of the base, the inner space communicating with the optical portions of the neighboring lenses.

20. The camera module as claimed in claim 19, wherein the sidewall of the barrel defines a plurality of spaced through holes corresponding to each pair of neighboring lenses, the spaced through holes arranged in a circumferential direction of the lenses.
